(19) United States
(12) Patent Application Publication
(10) Pub. No.: US 2015/0267861 A1
(43) Pub. Date: Sep. 24, 2015

(54) PUSH PRESSURE RELEASE

(71) Applicant: Peter Azof, Tracy, CA (US)

(72) Inventor: Peter Azof, Tracy, CA (US)

(21) Appl. No.: 14/735,017

(22) Filed: Jun. 9, 2015

Related U.S. Application Data
(60) Provisional application No. 62/010,162, filed on Jun. 10, 2014.

(51) Int. Cl. F16M 13/02; B65G 69/00

(52) U.S. Cl. CPC F16M 13/02; B65G 69/001

(57) ABSTRACT

The PUSH PRESSURE RELEASE comprises a pair of Rod Receivers coupled with a pair of Rod Holder having a Bumper with the Rod Receivers mounted to a building beside a dock bay. A tractor-trailer or large truck engages Bumper when backing to the dock bay causing the Rod Holders to press into the Rod Receivers. A Rod Receptacle within the Rod Receiver directs the Rod Holder upward, which alerts the driver that the tractor-trailer or large truck is close enough to the building, protects the building from damage, and along with an Upper Bumper attached to the Rod Holders, serves as weather protection between the building and the tractor-trailer or large truck.

### CROSS-REFERENCE TO RELATED APPLICATION

This application claims the benefit of priority of U.S. Provisional Patent Application 62/010,162 filed Jun. 10, 2014 and titled “Push Pressure Release,” the disclosure of which is incorporated by reference. This application is related to Utility Patent application Ser. No. 14/450,173 filed Aug. 1, 2014 and titled “Drop Pressure Release.”

### STATEMENT REGARDING FEDERALLY SPONSORED RESEARCH OR DEVELOPMENT

Not Applicable

### BACKGROUND OF THE INVENTION

1. Field of Invention

The invention relates generally to the field of devices relating to loading docks and more specifically to devices for protecting loading docks from damage as trailers are backed into the dock.

2. Description of Related Art

Docking a tractor-trailer to an elevated bay is a difficult experience. If the trailer strikes the building, serious damage may occur to the building as well as to the trailer. If the trailer is too far from the dock, a gap exists between the trailer and the building. At the least, the contents, equipment and dock workers may be subjected to severe weather during transfer, and HVAC costs are increased from outside air entering the building. Worse, the gap can hang-up a fork lift or cause a person to trip, either of which causes property damage and injury. Even small gaps can cause eventual knee and back pain as workers strain over the gap or misstep.

### SUMMARY OF THE INVENTION

Embodiments are directed to an apparatus for protecting a building from docking damage and for showing a position of an adjacent tractor-trailer or truck relative to a dock bay.

Disclosed are a Rod Receiver (100) comprising (FIG. 1) a Rod Receiver Back Plate (105) having a First Edge (105A) and a Second Edge (105B), with a First Rod Receiver Side Plate (110A) affixed to the Rod Receiver Back Plate (105) at the First Edge (105A), with a Second Rod Receiver Side Plate (110B) affixed to the Rod Receiver Back Plate (105) at the Second Edge (105B), with a First Rod Receptacle (115A) within First Rod Receiver Side Plate (110A), with a Second Rod Receptacle (115B) within Second Rod Receiver Side Plate (110B), with a First Rod Receptacle Upper Guide Rail (120A) within the First Rod Receptacle (115A) forming an upper edge of the First Rod Receptacle (115A), with a Second Rod Receptacle Upper Guide Rail (120) within the Second Rod Receptacle (115B) forming an upper edge of the Second Rod Receptacle (115B), with a First Rod Receptacle Slot (125A having a height ‘d_{H}’, within the First Rod Receptacle (115A) adjoining and perpendicular to the First Rod Receptacle Upper Guide Rail (120A), with a Second Rod Receptacle Slot (125B) having a height ‘d_{H}’, within the Second Rod Receptacle (115B adjoining and perpendicular to the Second Rod Receptacle Upper Guide Rail (120), with a First Rod Receptacle Outer Guide Rail (130A) within the First Rod Receptacle (115A) adjoining and parallel to the First Rod Receptacle Slot (125A), with a Second Rod Receptacle Outer Guide Rail (130B) within the Second Rod Receptacle (115) adjoining and parallel to the First Rod Receptacle Slot (125), with a First Rod Receptacle Lower Guide Rail (135) within the First Rod Receptacle (115A) adjoining the First Rod Receptacle Outer Guide Rail (130A) and terminating at the First Edge (105A) of the Rod Receiver Back Plate (105), with a Second Rod Receptacle Lower Guide Rail (135A) within the Second Rod Receptacle (115B) adjoining the Second Rod Receptacle Outer Guide Rail (130B) and terminating at the Second Edge (105B) of the Rod Receiver Back Plate (105), with a First Acute Incline Angle (140A) within the First Rod Receptacle (115A) formed between the First Rod Receptacle Outer Guide Rail (130A) and the First Rod Receptacle Lower Guide Rail (135A), and a Second Acute Incline Angle (140B) within the Second Rod Receptacle (115B) formed between the Second Rod Receptacle Outer Guide Rail (130B) and the Second Rod Receptacle Lower Guide Rail (135B).

Also disclosed is a Rod Holder (600) comprising (FIG. 6) a Rod Holder Back Plate (605) having a First Edge (605A) and a Second Edge (605B), with a Rod Holder Side Plate (610) affixed to the Rod Holder Back Plate (605) at the First Edge (605A) of the Rod Holder Back Plate (605), a Rod Holder Side Plate Rod Port (615) located within the Rod Holder Side Plate (610), with an Angled Side Plate (640) affixed to the Second Edge (605B) of the Rod Holder Back Plate (605), with an Angled Side Plate Rod Holder (625) located within the Angled Side Plate (640) and laterally across the Rod Holder Back Plate (605) from the Rod Holder Side Plate Rod Port (615), with at least one Outer Rod (635) having a diameter ‘d_{R}’ located within the Rod Holder Side Plate Rod Port (615) and the Angled Side Plate Rod Holder (625) and substantially perpendicular to the Rod Holder Side Plate (610), and a Rod Holder Bumper (650).

In some embodiments, the Rod Holder (600) further comprises an Inner Rod (630) concentrically inside of the at least one Outer Rod (635).

In some embodiments, the First Rod Receptacle Upper Guide Rail (120A) comprises a substantially right angle to the Rod Receiver Back Plate (105). (FIG. 1)

In some embodiments, the First Rod Receptacle Upper Guide Rail (120A) comprises an arc of approximately 90 degrees between the Rod Receiver Back Plate (105) and the First Rod Receptacle Slot (125A). (FIG. 2)

In some embodiments, a Rod Receiver Weather Seal (350) is affixed to the Rod

Receiver Back Plate (105) above the First Rod Receptacle Upper Guide Rail (120). (FIG. 3A)

In some embodiments, the Acute Incline Angle (140) between the Rod Receptacle Outer Guide Rail (130) and the Rod Receptacle Lower Guide Rail (135) is approximately 10 to 40 degrees above horizontal.

In some embodiments, the Rod Receiver (100) comprises a material selected from the group consisting of steel, iron, wood and plastic.

In some embodiments, the Rod Receiver (100) further comprises a First Rod Receiver Side Plate Connector (560) affixed to the First Rod Receiver Side Plate (110A) and a Second Rod Receiver Side Plate Connector (565) affixed to the Second Rod Receiver Side Plate (110B). (FIG. 5)

Also disclosed is an apparatus for protecting a dock bay comprising a Rod Receiver (100) coupled with a Rod Holder (600) wherein a height ‘d_{H}’ of a Rod Receptacle Slot (125) of the Rod Receiver (100) is greater than a diameter ‘d_{R}’ of an at least one Outer Rod (635) of a Rod Holder (600) with a Rod Holder Bumper (650) coupled to a Rod Holder Back Plate (605) of the Rod Holder (600) on a face opposite of an Angled Side Plate (640) affixed to the Rod Holder Back Plate (605). (FIGS. 9 & 10)

The apparatus for protecting a dock bay may further comprise an Upper Bumper (1100) having an Upper Bumper Base (1105), with at least one Upper Bumper Angled Side Plate (1110) affixed to the Upper Bumper Base, with at least one Upper Bumper Attachment Port within the at least one Upper Bumper Angled Side Plate (1110) and an Upper Bumper Bumper (1150) attached to the Upper Bumper Base (1105) adjacent to the at least one Upper Bumper

### BRIEF DESCRIPTION OF THE DRAWINGS

FIG. 1 shows an exemplary Rod Receiver (100) of the PUSH PRESSURE RELEASE.

FIG. 2 shows an alternate embodiment (100) of the Rod Receiver of the PUSH PRESSURE RELEASE.

FIG. 3 shows an alternate embodiment (300) of the Rod Receiver of the PUSH PRESSURE RELEASE.

FIG. 4 shows a side view of the alternate embodiment (300) of the Rod Receiver of the PUSH PRESSURE RELEASE.

FIG. 5A and 5B show alternate embodiments (500A and 500B) with the alternate embodiment (300) of the Rod Receiver of the PUSH PRESSURE RELEASE.

FIG. 6A and 6B show an embodiment of a Rod Holder (600).

FIG. 7 shows an alternate view a Rod Holder (600) showing the Rod Holder Bumper (650).

FIG. 8 shows an alternate view a Rod Holder (600) and the Rod Holder Bumper (650).

FIG. 9 shows a Rod Receiver (100) mounted to a Building (‘B’) with Rod Holder (600) in position for placement within Rod Receiver (100).

FIG. 10 shows a Rod Holder (600) positioned within Rod Receiver (100).

FIG. 11A, 11B and 11C show an embodiment of an Upper Bumper (1100).

FIG. 12A and 12B show an exemplary installation of the PUSH PRESSURE RELEASE.

### DETAILED DESCRIPTION OF THE INVENTION

In one embodiment, the PUSH PRESSURE RELEASE comprises two primary components. A Rod Receiver (100) is attached beside a dock bay, outside of a building, while a Rod Holder (600) rests within the Rod Receiver (100) with a Rod Holder Bumper (650) facing outwards. In most embodiments, there are two sets comprising a Rod Receiver (100) and a Rod Holder (600). One set is mounted immediately left of the dock bay, while the other set, which is a mirror image of the first set, is mounted immediately right of the dock bay.

When a tractor-trailer or large truck backs in and contacts the PUSH PRESSURE RELEASE, the Rod Holder (600) moves both towards the building and upwards, thereby giving a clear indication that the tractor-trailer or large truck is in contact with the PUSH PRESSURE RELEASE. As the PUSH PRESSURE RELEASE is several inches in depth, the driver can stop the tractor-trailer or large truck before direct contact is made with the building, thus preventing damage to the building.

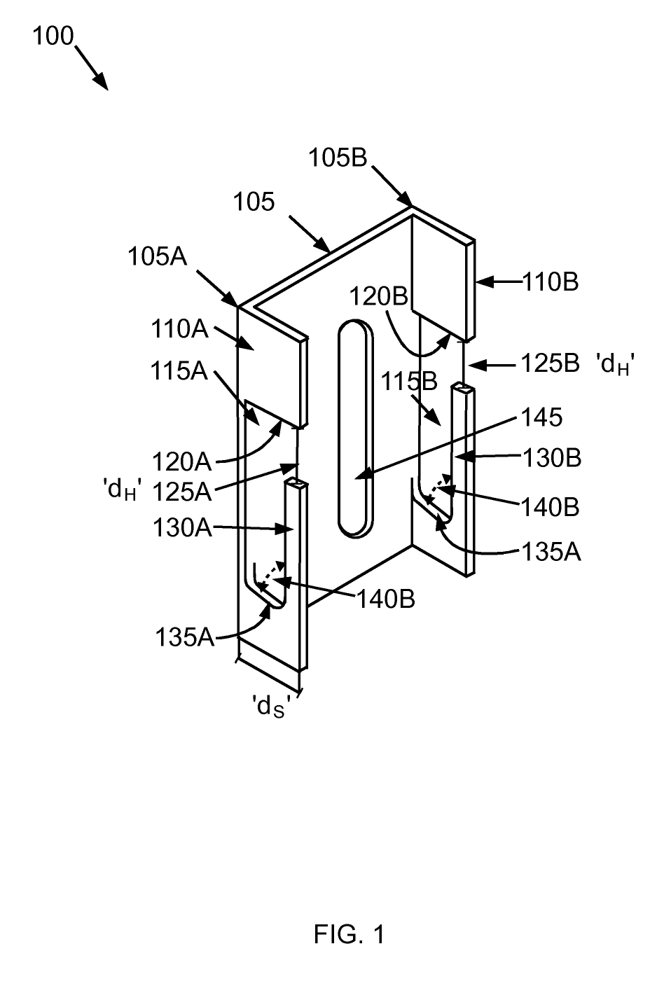

FIG. 1 shows an exemplary Rod Receiver (100) of the PUSH PRESSURE RELEASE. Shown in FIG. 1 is a Rod Receiver (100), having a Rod Receiver Back Plate (105) having a First Edge (105A) and a Second Edge (105B), a First Rod Receiver Side Plate (110A) coupled to the Rod Receiver Back Plate (105) at the First Edge (105A), a Second Rod Receiver Side Plate (110B) coupled to the Rod Receiver Back Plate (105) at the Second Edge (105B), a First and a Second Rod Receptacle (115A and 115B) within each Rod Receiver Side Plate (110A and 110B), with the First and the Second Rod Receptacle (115A and 115B) having a Rod Receptacle Upper Guide Rail (120A and 120B), a Rod Receptacle Slot (125A and 125B), a Rod Receptacle Outer Guide Rail (130A and 130B), a Rod Receptacle Lower Guide Rail (135A and 135B), and an Acute Incline Angle (140A and 140B). Also shown is a Rod Receiver Mounting Slot (145) within the Rod Receiver Back Plate (105).

The Rod Receiver Back Plate (105) is the support structure for the Rod Receiver (100) in that the other components of the Rod Receiver (100) are affixed directly or indirectly to the Rod Receiver Back Plate (105). In most embodiments, the Rod Receiver Back Plate (105) is affixed to the building around the dock bay.

The Rod Receiver Back Plate (105) is the also support structure for the PUSH PRESSURE RELEASE in that the Rod Receiver Back Plate (105) receives any forces transmitted from Rod Holder (600) when a tractor-trailer contacts the Rod Holder (600).

In most embodiments, the Rod Receiver Back Plate (105) would be a strong grade of steel or other metal so as to provide its function with high reliability. The Rod Receiver Back Plate (105) could be lesser grades of steel, iron, less strong metals, or even wood or plastic, with the functional exchange being the amount of force to which the Rod Receiver (100) would be subjected against the reliability and life of the Rod Receiver Back Plate (105).

The First and the Second Rod Receiver Side Plates (110A and 110B) are affixed to the Rod Receiver Back Plate (105), one along each edge (First Edge 105A and Second Edge 105B) of the Rod Receiver Back Plate (105), and serve as the support structure for other components of the Rod Receiver (100). The First and the Second Rod Receiver Side Plates (110A and 110B) run the height of each side the Rod Receiver (100). Although the First and the Second Rod Receiver Side Plates (110A and 110B) may be formed in parts, e.g., an upper part and a lower part, each of the First and the Second Rod Receiver Side Plates (110A and 110B) may be one piece integrated into, or affixed, including being welded, to the Rod Receiver Back Plate (105).

Each of the First and the Second Rod Receiver Side Plates (110A and 110B) has a Rod Receptacle (115A and 115B), each which comprises a Rod Receptacle Upper Guide Rail (120A and 120B), a Rod Receptacle Slot (125A and 125B), a Rod Receptacle Outer Guide Rail (130A and 130B), a Rod Receptacle Lower Guide Rail (135A and 135B), and an Acute Incline Angle (140A and 140B). These may be integrated into, or affixed to the respective Rod Receiver Side Plate (110A and 110B).

In most embodiments, the First and the Second Rod Receiver Side Plates (110A and 110B) would be made from a strong grade of steel or other metal so as to provide its function with high reliability. The First and the Second Rod Receiver Side Plates (110A and 110B) could be lesser grades of steel, iron, less strong metals, or even wood or plastic, with the functional exchange being the amount of force to which the First and the Second Rod Receiver Side Plates (110A and 110B) would be subjected against the reliability and life of the Rod Receiver Back Plate (105).

The First and the Second Rod Receiver Side Plates (110A and 110B) may be integrally formed onto the Rod Receiver Back Plate (105) as part of the Rod Receiver (100). The First and the Second Rod Receiver Side Plates (110A and 110B) may be welded onto the Rod Receiver Back Plate (105) as part of the Rod Receiver (100). Other methods of attaching the First and the Second Rod Receiver Side Plates (110A and 110B) onto the Rod Receiver Back Plate (105) are possible.

On receiving the forces when the halves of the PUSH PRESSURE RELEASE connect, the First and the Second Rod Receiver Side Plates (110A and 110B) partially absorb the forces, and partially transmits the forces to the Rod Receiver Back Plate (105).

The First and the Second Rod Receptacles (115A and 115B) of the First and the

Second Rod Receiver Side Plates (110A and 110B) receive and hold the Rod Holder (600) within the Rod Receiver (100). Each of the First and the Second Rod Receptacles (115A and B) comprises multiple functional portions that together serve to guide the Rods of the Rod Holder (600). Among these functional portions are the First and the Second Rod Receptacle Upper Guide Rail (120A and 120B), the First and the Second Rod Receptacle Slots (125A and 125B), the First and the Second Rod Receptacle Outer Guide Rails (130A and 130B), and the First and the Second Rod Receptacle Lower Guide Rails (135A and 135B).

In most embodiments, the First and the Second Rod Receptacle Upper Guide Rails (120A, 120B), the First and the Second Rod Receptacle Outer Guide Rails (130A, 130B), and the First and the Second Rod Receptacle Lower Guide Rails (135A, 135B) of the First and the Second Rod Receptacles (115A and 115B) would be a strong grade of steel or other metal so as to provide the functions with high reliability. These portions of the First and the Second Rod Receptacles (115A and 115B) could be lesser grades of steel, iron, less strong metals, or even wood or plastic, with the functional exchange being the amount of force to which the Rod Receiver (100) would be subjected against the reliability and life of the Rod Receptacles (115A and 115B).

As the First Rod Receiver Side Plate (110A) and the Second Rod Receiver Side Plate are identical in structure and function, these next descriptions refer to the Rod Receptacles (115) and structure of both the First Rod Receiver Side Plate (110A) and the Second Rod Receiver Side Plate (110B).

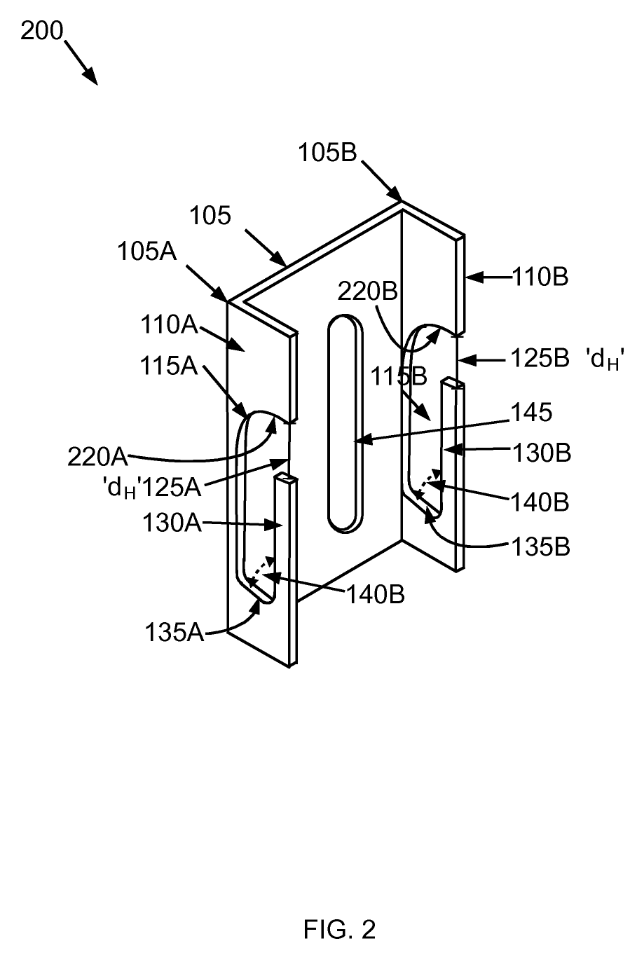

The Rod Receptacle Upper Guide Rails (120A and 120B) is an upper portion of the Rod Receptacles (115A and 115B) with the function to guide the Inner and Outer Rods of the Rod Holder (600) within the Rod Receiver (100) when the Rod Holder (600) is being coupled or uncoupled with the Rod Receiver (100). As shown in FIG. 1, the Rod Receptacle Upper Guide Rails (120A and 120B) comprise a substantially right angle to the Rod Receiver Back Plate (105) in some embodiments. In other embodiments, as shown in FIG. 2, the Rod Receptacle Upper Guide Rails (120A and 120B) comprise an arc of approximately 90 degrees between the Rod Receiver Back Plate (105) and the First Rod Receptacle Slot, with a near horizontal portion near the Rod Receptacle Slot (125) and a near vertical portion near the Rod Receiver Back Plate (105). The arc of the Rod Receptacle Upper Guide Rails (120A and 120B) could be as much as 15 degrees from 90 degrees in a preferred embodiment, but such circumstances are likely to involve a hybrid of an arc section and a flat section along the Rod Receiver Back Plate (105).

The Rod Receptacle Slot (125) is the entry and exit location for the Inner Rod (630) and the at least one Outer Rod (635) of Rod Holder (600) of the PUSH PRESSURE RELEASE to mate together the Rod Receiver (100) with the Rod Holder (600). The Rod Receptacle Slot (125) is sized with a dimension ‘d_{H}’ which must be sized allow at least one Outer Rod (635) sized ‘d_{R}’ to pass through as to allow the Rod Receiver (100) to receive the Rod Holder (600). Typically the Rod Receptacle Slots (125A and 125B) are slightly larger or more than the rods of the Rod Holder (600) to allow spacing for minor assembly alignment variations and fluctuations that occur in the manufacture of rods. Since in some embodiments, the at least one Outer Rod (635, ‘d_{R}’) has a diameter of approximately one-half inch, then ‘d_{H}’ is larger than one-half inch. In some embodiments, ‘d_{H}’ is approximately 5 to 50 per cent larger than ‘d_{R}’. In use, the at least one Outer Rod (635, ‘d_{R}’) may have a diameter of one-quarter inch to one inch. The determinative factors for the diameter of the at least one Outer Rod (635, ‘d_{R}’) include the type, ability to stop, and weight of tractor-trailer for which the PUSH PRESSURE RELEASE is installed, and the sturdiness of the building.

The Rod Receptacle Outer Guide Rails (130A and 130B) are a portion of the Rod Receptacles (115A and 115B) with the function to retain the Rod Holder (600) properly coupled to the Rod Receiver (100). When a tractor-trailer is not in contact with the PUSH PRESSURE RELEASE (and during coupling of the Rod Receiver (100) and the Rod Holder (600)), the Rod Receptacle Outer Guide Rails (130A and 130B) are a physical barrier to keep the Outer Rods of the Rod Holder (600) within the Rod Receptacle (115), and thus within the Rod Receiver (100). When a tractor-trailer is not in contact with the PUSH PRESSURE RELEASE, the Rod Receptacle Outer Guide Rails (130A and 130B), which at the furthest point is a distance ‘dₛ’ from the Rod Receiver Back Plate (105), is a barrier such that the Rod Holder Back Plate (605) of the Rod Receiver (100) contacts the Rod Receptacle Outer Guide Rails (130A and 130B) and stops the Rod Holder (600) from contacting the building, and thus stops the tractor-trailer or large truck from contacting the building.

Within the Rod Receptacles (115A and 115B) is a Rod Receptacle Lower Guide Rail (135A and 135B), which adjoins the Rod Receptacle Outer Guide Rails (130A and 130B) and terminates at the Rod Receiver Back Plate (105). The Rod Receptacle Lower Guide Rails (135A and 135B) angle upward towards the Rod Receiver Back Plate (105). When a tractor-trailer or large truck contacts the PUSH PRESSURE RELEASE and presses the Rod Holder (600) of the PUSH PRESSURE RELEASE towards the building, the Rod Receptacle Lower Guide Rails (135A and 135B) direct the Rod Holder (600) upward and towards the Rod Receiver Back Plate (105), thus giving a clear visual cue that the tractor-trailer or large truck has contacted the PUSH PRESSURE RELEASE.

In some embodiments, the Rod Receptacle Lower Guide Rails (135A and 135B) have a length of approximately twice the diameter of the at least one Outer Rod (635) of the Rod

Holder (600), discussed below.

Formed by the adjoined Rod Receptacle Outer Guide Rail (130A and 130B) and the Rod Receptacle Lower Guide Rail (135A and 135B), is the Acute Incline Angle (140A and 140B), which provides an upward direction to the Rod Holder (600) as it moves towards the Rod Receiver Back Plate (105). In a preferred embodiment, the Acute Incline Angle is angled approximately 15 degrees above horizontal, although angles of 10 to 40 degrees produce optimum movement of the Rod Holder (600) to serve as a visual cue.

To mount the Rod Receiver (100) to a building, a Rod Receiver Mounting Slot (145) may be placed within the Rod Receiver Back Plate (105).

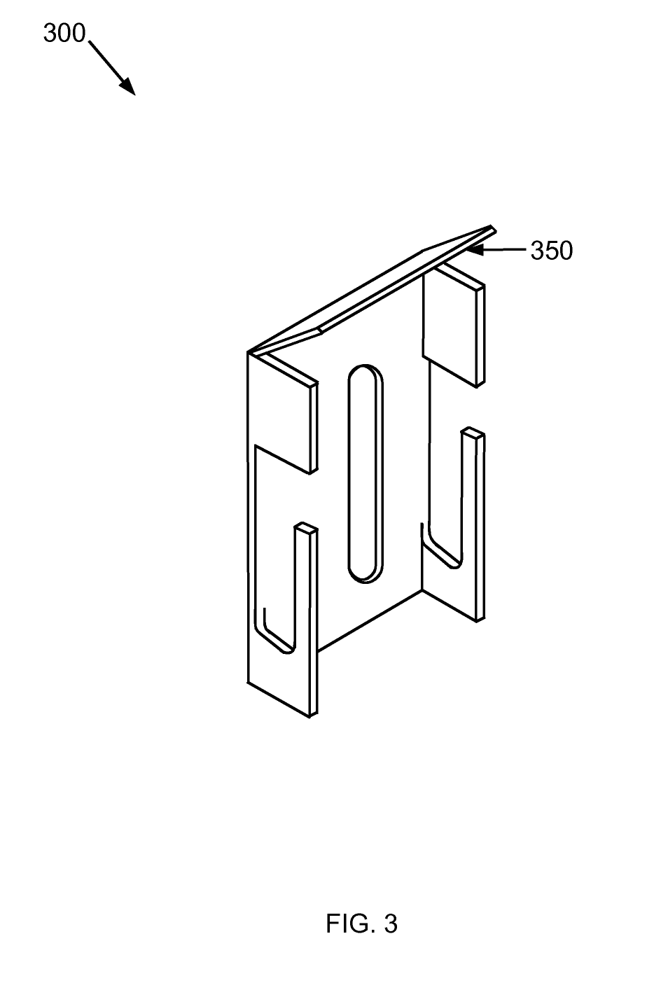

FIG. 3 shows an alternate embodiment (300) of the Rod Receiver (100) of the PUSH PRESSURE RELEASE. Shown in FIG. 3A are a Rod Receiver with a Rod Receiver Weather Seal (300) having a Rod Receiver (100) with a Rod Receiver Weather Seal (350). The Rod Receiver Weather Seal (350) provides weather protection to the Rod Receiver (100). The Rod Receiver Weather Seal (350) may be angled with respect to the Rod Receiver (100) or may be flat across the Rod Receiver (100). The Rod Receiver Weather Seal (350) may be made of the same material as the Rod Receiver (100). The Rod Receiver Weather Seal (350) may be welded or otherwise affixed to the Rod Receiver (100). In some embodiments, the Rod Receiver Weather Seal (350) may be affixed with bolts. In some embodiments, the Rod Receiver Weather Seal (350) may be hinged to the Rod Receiver (100).

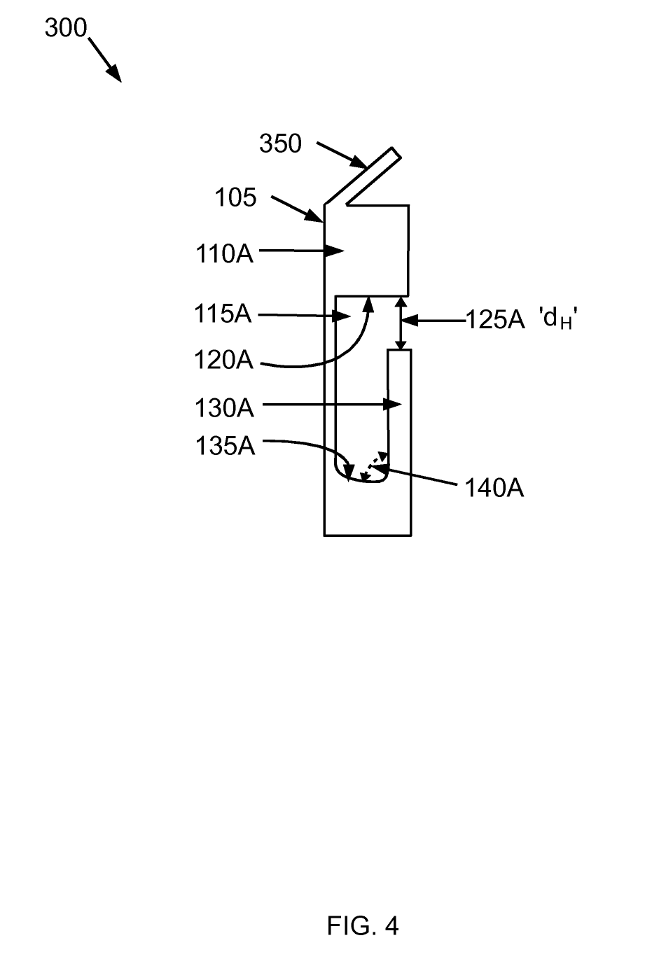

FIG. 4 shows a side view of the alternate embodiment (300) of the Rod Receiver (100) with a Rod Receiver Weather Seal (350) of the PUSH PRESSURE RELEASE. Shown in FIG. 4 are a side view of the Rod Receiver Back Plate (105), the First Rod Receiver Side Plate (110A), the First Rod Receptacle (115A), the First Rod Receptacle Upper Guide Rail (120A), the

First Rod Receptacle Slot (125A), the First Rod Receptacle Outer Guide Rail (130A), the First Rod Receptacle Lower Guide Rail (135A), the First Acute Incline Angle (140A), and the Rod Receiver Weather Seal (350).

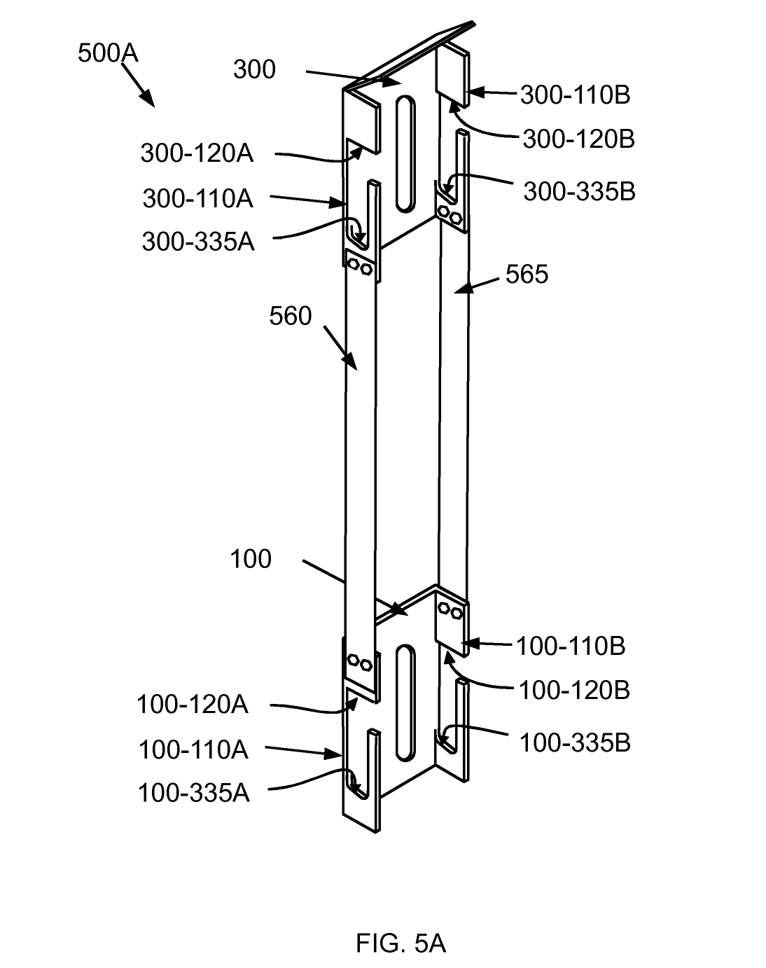

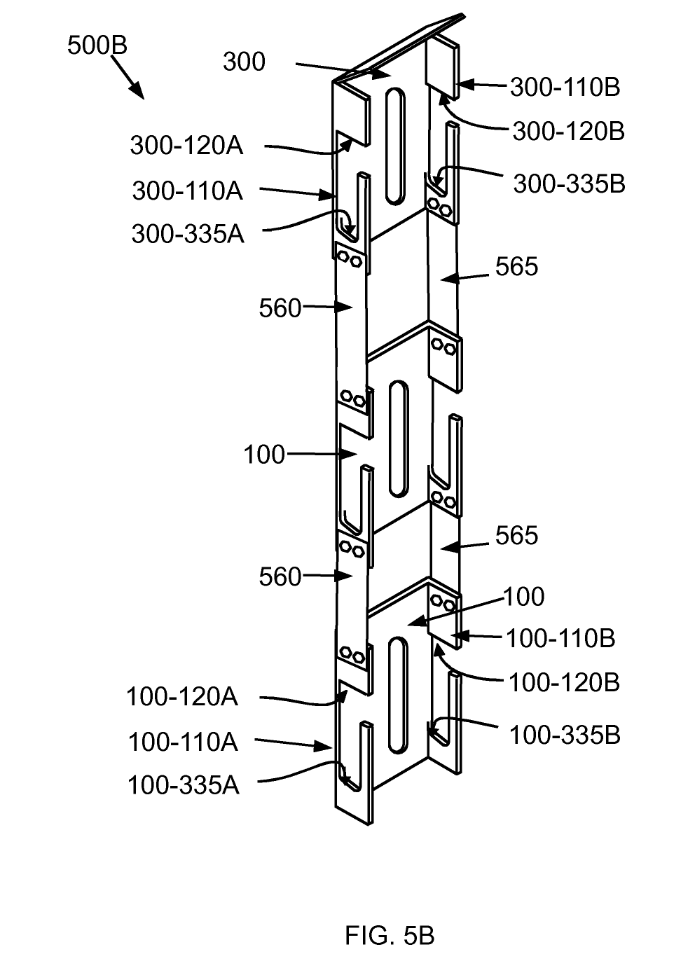

FIG. 5A and 5B show alternate embodiments (500A and 500B) with the alternate embodiment (300) of the Rod Receiver of the PUSH PRESSURE RELEASE.

Shown in FIG. 5A are a Rod Receiver Assembly (500A) comprising a plurality of Rod Receivers, one having the configuration of the Rod Receiver (100) with a Rod Receiver Weather Seal (300), and the other having the configuration of the regular Rod Receiver (100). In this embodiment, the Rod Receivers are joined together with a First Rod Receiver Side Plate Connector (560) and a Second Receiver Side Plate Connector (565).

The First Rod Receiver Side Plate Connector (560) is affixed to the Rod Receiver with Rod Receiver Weather Seal (300) at the First Rod Receiver Side Plate (300-110A) below the Rod Receptacle Lower Guide Rail (300-335A), and to the Rod Receiver (100) in the middle at the First Rod Receiver Side Plate (100-110A) above the Rod Receptacle Upper Guide Rail (100-120A).

The Second Rod Receiver Side Plate Connector (565) is affixed to the Rod Receiver with Rod Receiver Weather Seal (300) at the Second Rod Receiver Side Plate (300-110B) below the Rod Receptacle Lower Guide Rail (300-335B), and to the Rod Receiver (100) at the Second Rod Receiver Side Plate (100-110B) above the Rod Receptacle Upper Guide Rail (100-120B).

The First Rod Receiver Side Plate Connector (560) and the Second Rod Receiver Side Plate Connector (565) may be bolted to the Rod Receiver with Rod Receiver Weather Seal (300) and the Rod Receiver (100). The First Rod Receiver Side Plate Connector (560) and the Second Rod Receiver Side Plate Connector (565) may be welded to the Rod Receiver with Rod Receiver Weather Seal (300) and the Rod Receiver (100).

In some embodiments the First Rod Receiver Side Plate Connector (560) and the Second Rod Receiver Side Plate Connector (565) may be manufactured together with to the Rod Receiver with Rod Receiver Weather Seal (300) and the Rod Receiver (100).

The embodiment is beneficial in that various embodiments of the Rod Receiver (100 or 300) may be made and where needed, adapted to dock bays of different heights and widths using different length components of the First Rod Receiver Side Plate Connector (560) and the Second Rod Receiver Side Plate Connector (565).

Shown in FIG. 5B are a Rod Receiver Assembly (500B) comprising a plurality of Rod Receivers, one having the configuration of the Rod Receiver with Rod Receiver Weather Seal (300), with two of the Rod Receiver (100). In this embodiment, the Rod Receivers are joined together with a plurality of First Rod Receiver Side Plate Connectors (560) and a Second Receiver Side Plate Connectors (565).

The embodiment is beneficial in that various embodiments of the Rod Receiver (100, 300) may be made and where needed, adapted to dock bays of different heights and widths using different length components of the First Rod Receiver Side Plate Connector (560) and the Second Rod Receiver Side Plate Connector (565). The embodiment is particularly beneficial when heavier tractor-trailer loads place a higher risk of damage to a building.

The Rod Receiver Assembly (500B) may comprise one Rod Receiver having the configuration of the Rod Receiver with Rod Receiver Weather Seal (300), with two of the Rod Receiver (100), two Rod Receivers (100), three Rod Receiver (100), or any configuration of Rod Receivers (100).

Such an embodiment may comprise at least two Rod Receivers (100) with the First Rod Receiver Side Plate Connector (560) affixed to a First Rod Receiver (100A) below the First Rod Receptacle Lower Guide Rail (100A-335A) and to a Second Rod Receiver (100B) at the Second Rod Receiver Side Plate (100B-110A) above the Second Rod Receptacle Upper Guide Rail (100B-120A), with the Second Rod Receiver Side Plate Connector (565) affixed to the First Rod Receiver (100A) at the Second Rod Receiver Side Plate (100A-110B) below the Second Rod Receptacle Lower Guide Rail (100A-335B), and to the Second Rod Receiver (100B) at the Second Rod Receiver Side Plate (100B-110B) above the Second Rod Receptacle Upper Guide Rail (100B-120B).

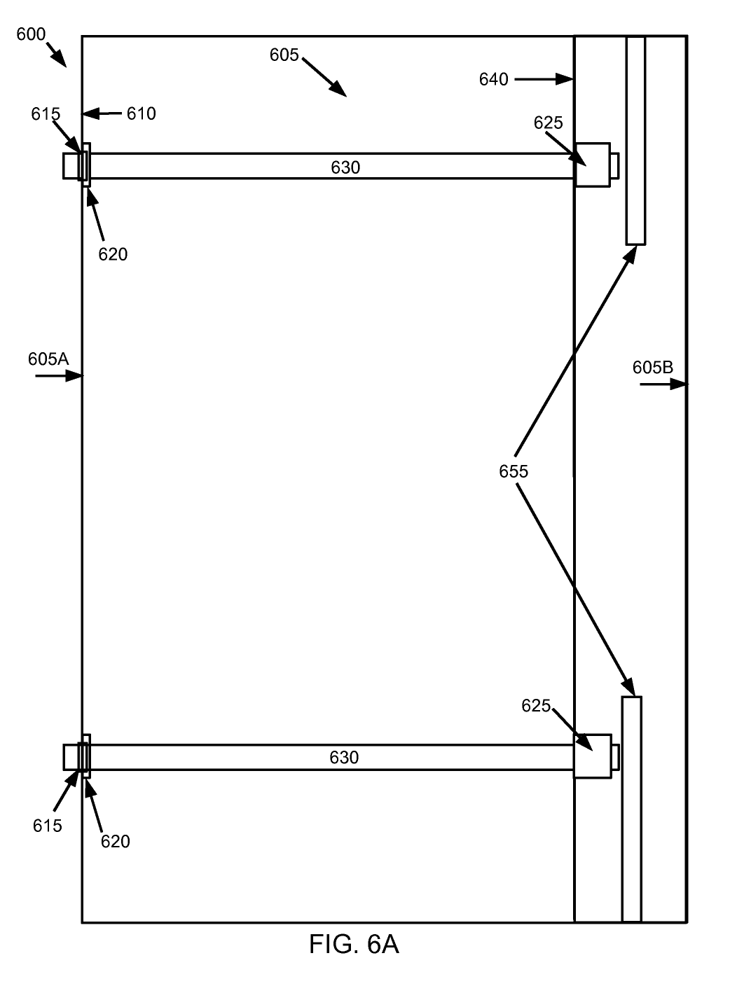

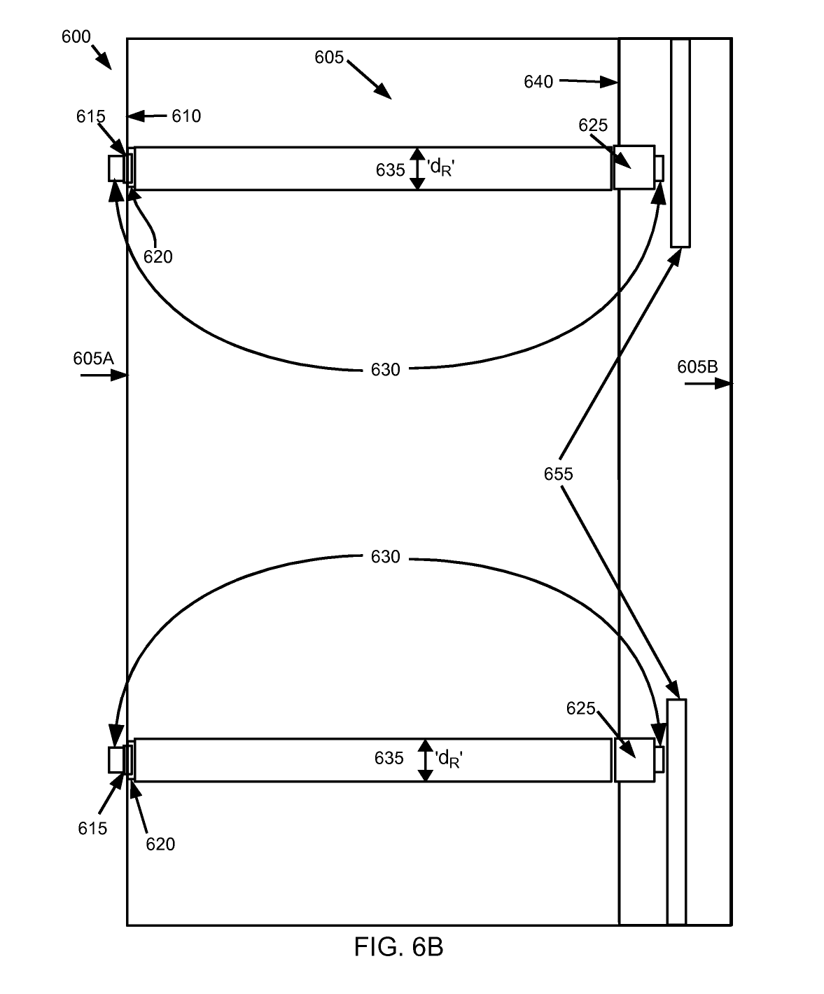

FIG. 6A and 6B show an embodiment of a Rod Holder (600). FIG. 6A shows the Rod Holder (600) with an Inner Rod (630). The at least one Outer Rod (635) is omitted for viewing the Inner Rod (630). FIG. 6B shows the Rod Holder (600) with the at least one Outer Rod (635). The Inner Rod (630) is not visible as it is inside the at least one Outer Rod (635). Some embodiments may omit the Inner Rod (630), though for consistency, the PUSH PRESSURE RELEASE will be described as if the Inner Rod (630) is present.

Shown in FIG. 6A and 6B are a Rod Holder (600) comprising a Rod Holder Back Plate (605) having a First Edge (605A) and a Second Edge (605B), with a Rod Holder Side Plate (610) affixed to the Rod Holder Back Plate (605) at the First Edge (605A) of the Rod Holder Back Plate (605), two Rod Holder Side Plate Rod Port (615) located within the Rod Holder Side Plate (610), two Rod Holder Side Plate Spacer (620), with an Angled Side Plate (640) affixed to the Second Edge (605B) of the Rod Holder Back Plate (605), with an Angled Side Plate Rod Holder (625) located within the Angled Side Plate (640) and laterally across the Rod Holder

Back Plate (605) from the Rod Holder Side Plate Rod Port (615), with an Inner Rod (630) located within the Rod Holder Side Plate Rod Port (615) and the Angled Side Plate Rod Holder (625) and substantially perpendicular to the Rod Holder Side Plate (610), and at least one Outer Rod (635) concentrically outside of the Inner Rod with the at least one Outer Rod (635) having a diameter ‘d_{R}’.

While FIG. 6A and 6B show the Rod Holder (600) having two sets of a Rod Holder Side Plate Rod Port (615), Rod Holder Side Plate Spacer (620), Angled Side Plate Rod Holder (625), Inner Rod (630) and at least one Outer Rod (635), the Rod Holder (600) is conducive to having one set, and like the Rod Receiver (100), having connector plates between then. Thus, while the drawings FIG. 6A, 6B, and 8 show two sets of these structures, this is representative of one embodiment, and not limiting as to no include a Rod Holder (600) with set of Rod Holder Side Plate Rod Port (615), Rod Holder Side Plate Spacer (620), Angled Side Plate Rod Holder (625), Inner Rod (630) and at least one Outer Rod (635).

Unlike the Rod Receiver (100), which is affixed to a building, the Rod Holder (600) is designed to rest freely on the Rod Receiver (100). In resting freely, the Rod Holder (600) is free to move when contacted by a tractor-trailer or truck.

The Rod Holder Back Plate (605) is the support structure for the Rod Holder (600) in that the other components of the Rod Holder (600) are affixed directly or indirectly to the Rod Holder Back Plate (605).

The Rod Holder Back Plate (605) is the also primary structure for the PUSH PRESSURE RELEASE in that the Rod Holder Back Plate (605) receives the direct force of a tractor-trailer or truck that contacts the PUSH PRESSURE RELEASE.

In most embodiments, the Rod Holder Back Plate (605) would be a strong grade of steel or other metal so as to provide its function with high reliability. The Rod Holder Back Plate (605) could be lesser grades of steel, iron, less strong metals, or even wood or plastic, with the functional exchange being the amount of force to which the PUSH PRESSURE RELEASE would be subjected against the reliability and life of the Rod Holder Back Plate (605).

The Rod Holder Side Plate (610) is affixed to the Rod Holder Back Plate (605) at the First Edge (605A) of the Rod Holder Back Plate (605), and serves as the support structure for other components of the Rod Holder (600).

In most embodiments, the Rod Holder Side Plate (610) would be a strong grade of steel or other metal so as to provide its function with high reliability. The Rod Holder Side Plate (610) could be lesser grades of steel, iron, less strong metals, or even wood or plastic, with the functional exchange being the amount of force to which the PUSH PRESSURE RELEASE would be subjected against the reliability and life of the at least one Rod Holder Side Plate (610).

The Rod Holder Side Plate (610) may be integrally formed onto the Rod Holder Back Plate (605) as part of the Rod Holder (600). The Rod Holder Side Plate (610) may be welded onto the Rod Holder Back Plate (605) as part of the Rod Holder (600). Other methods of attaching the Rod Holder Side Plate (610) onto the Rod Holder Back Plate (605) are possible.

Within the Rod Holder Side Plate (610) is a Rod Holder Side Plate Rod Port (615), which is the supporting structure for the Inner Rod (630) and at least one Outer Rod (635) of the Rod Holder (300). In the preferred embodiment, the Rod Holder Side Plate Rod Port (615) must be sized to accept and hold the Inner Rod (630), which is the supporting structure for the at least one Outer Rod (635) of the Rod Holder (300). In some embodiments, the Rod Holder Side Plate Rod Port (615) must be sized to accept and hold the at least one Outer Rod (635), although having a freely rotating at least one Outer Rod (635) over the Inner Rod (630) is advantageous to smooth operation of the PUSH PRESSURE RELEASE.

In most embodiments, adjacent to the Rod Holder Side Plate Rod Port (615) is a Rod Holder Side Plate Spacer (620), which provides spacing to reduce friction between the at least one Outer Rod (635) and the Rod Holder Side Plate (610) so the at least one Outer Rod (635) is freely rotating. The Rod Holder Side Plate Spacer (620) also serves to reduce corrosion binding the at least one Outer Rod (635) to the Rod Holder Side Plate (610). The Rod Holder Side Plate Spacer (620) may be made of metal for durability, although some plastics (e.g., the Acetal Resin ‘Delrin’) have high stiffness and strength and may be suitable. Some embodiments may omit the Rod Holder Side Plate Spacer (620), or incorporate the Rod Holder Side Plate Spacer (620) into the Inner Rod (630) or the at least one Outer Rod (635).

Affixed to the Second Edge (605B) of the Rod Holder Back Plate (605) is an Angled Side Plate (640), which serves as a second side to support the Inner Rod (630) and the at least one Outer Rod (635) of the Rod Holder (300).

The Inner Rod (630) provides support for the at least one Outer Rod (635) by being sufficiently secure in position in the Rod Holder (600) so the at least one Outer Rod (635) may rotate freely as the Rod Holder (600) moves back and forth. Like other components of the Rod Holder (600), the Inner Rod (630) would be a strong grade of steel or other metal so as to provide its function with high reliability. The Inner Rod (630) could be lesser grades of steel, iron, less strong metals, or even wood or plastic, with the functional exchange being the amount of force to which the PUSH PRESSURE RELEASE would be subjected against the reliability and life of the Inner Rod (630).

The at least one Outer Rod (635) serves as the supporting structure for the Rod Holder (600) when it is within the Rod Receiver (100). When a tractor-trailer or large truck contacts the Rod Holder (600), the at least one Outer Rod (635) is pushed back within the Rod Receptacles (115A and 115B). To reduce friction and wear on the Rod Receptacles (115A and 115B) and the at least one Outer Rod (635), the at least one Outer Rod (635) should be freely rotating, as by having an Inner Rod (630) within the at least one Outer Rod (635).

As with the other components of the Rod Holder (600), the at least one Outer Rod (635) would be a strong grade of steel or other metal so as to provide its function with high reliability. The at least one Outer Rod (635) could be lesser grades of steel, iron, less strong metals, or even wood or plastic, with the functional exchange being the amount of force to which the PUSH PRESSURE RELEASE would be subjected against the reliability and life of the at least one Outer Rod (635).

In most embodiments, the Angled Side Plate (640) would be a strong grade of steel or other metal so as to provide its function with high reliability. The Angled Side Plate (640) could be lesser grades of steel, iron, less strong metals, or even wood or plastic, with the functional exchange being the amount of force to which the PUSH PRESSURE RELEASE would be subjected against the reliability and life of the Rod Holder (600).

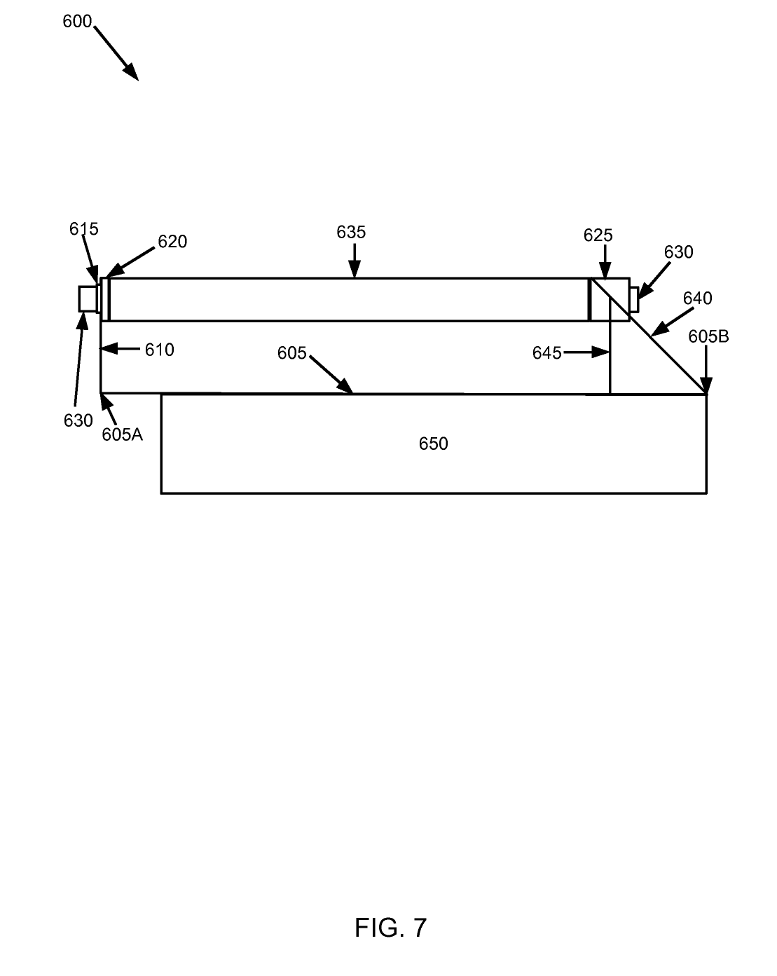

As shown in alternate view FIG. 7, the Angled Side Plate (640) has an angle to the Rod Holder Back Plate (605) of about 45 degrees. The actual angle is not critical, although the Rod Holder (600) is easier to handle for installation and removal by having an acute angle.

Also shown in FIG. 7 is the Angled Side Plate Support Plate (645), which serves to support the Angled Side Plate (640). As with the other components of the Rod Holder (600), the Angled Side Plate Support Plate (645) would be a strong grade of steel or other metal so as to provide its function with high reliability. The Angled Side Plate Support Plate (645) could be lesser grades of steel, iron, less strong metals, or even wood or plastic, with the functional exchange being the amount of force to which the PUSH PRESSURE RELEASE would be subjected against the reliability and life of the Rod Holder (600).

As shown in FIG. 7, the Angled Side Plate Rod Holder (625) is partially embedded in Angled Side Plate Rod Holder (625) to provide additional strength support for the Rod Holder (600) when contacted by tractor-trailer or large truck.

The Angled Side Plate Support Plate positioned at substantially a right angle to the Rod Holder Back Plate (605) and between the Angled Side Plate Rod Holder (625) and the Rod Holder Back Plate (605).

Also shown in FIG. 7 is the Rod Holder Bumper (650).

The Rod Holder Bumper (650) is attached to the Rod Holder Back Plate (605) of the Rod Holder (600) but on a face away from the at least one Outer Rod (635), so that the Rod Holder Bumper (650) is adjacent to any vehicle approaching the PUSH PRESSURE RELEASE.

In this configuration, the Rod Holder Bumper (650) cushions the building and the PUSH PRESSURE RELEASE from a full impact from a tractor-trailer or other docking vehicle. The Rod Holder Bumper (650) may be made from any material, including rubber, wood, steel, iron, other natural materials, other natural elastic materials, recycled rubber, plastic, a composite of rubber and plastic, other artificial materials, or other artificial elastic materials.

The Rod Holder Bumper (650) may be any thickness, although the effectiveness of the Rod Holder Bumper (650) depends on both the material and thickness, as well as the vehicle contacting the PUSH PRESSURE RELEASE. In some embodiments, the Rod Holder Bumper (650) may be recycled rubber with a thickness of approximately six inches. The Rod Holder Bumper (650) may be attached to the Rod Holder Back Plate (605) by any method suitable of attaching a bumper. In some embodiments, one or more fasteners may be used to attach the Rod Holder Bumper (650) to the Rod Holder Back Plate (605). The one or more fasteners may be screws, bolts, clips, clamps, staples, rivets or other fasteners. In some embodiments, an adhesive may be used to attach the Rod Holder Bumper (650) to the Rod Holder Back Plate (605).

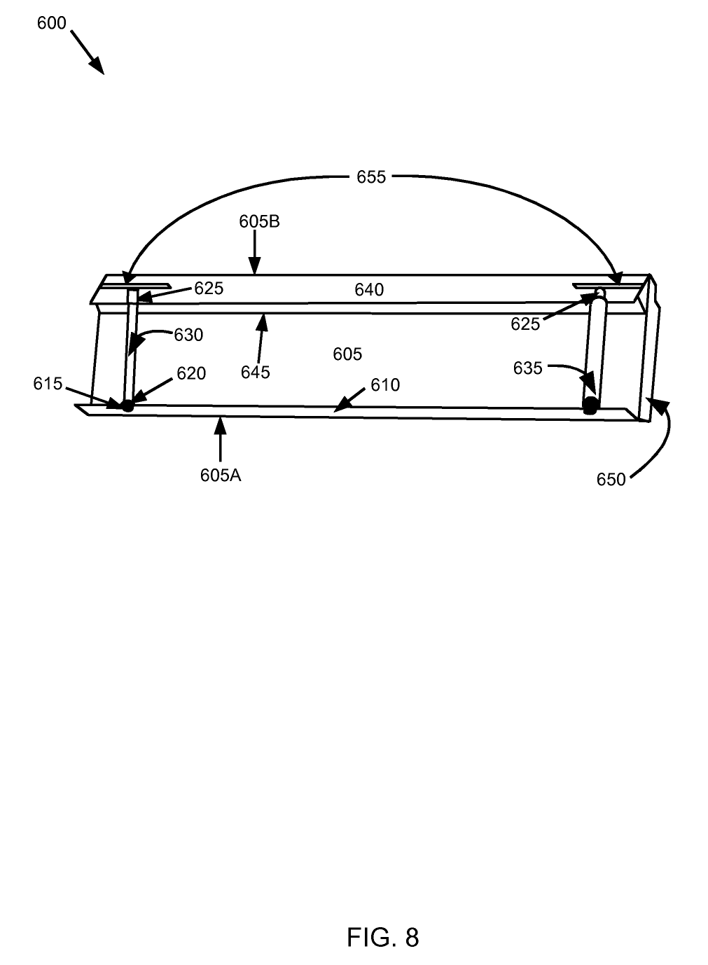

As shown on FIG. 8, the Rod Holder Bumper (650) may have one edge of lesser thickness so as to be conducive to being clamped to the Rod Holder Back Plate (605).

FIG. 8 shows an alternate view of a slightly different embodiment of the Rod Holder (600) and the Rod Holder Bumper (650). In this embodiment, the Rod Holder Bumper (650) has a lip along the side underneath the Angled Side Plate (640). In certain embodiments, this lip is beneficial for clamping the Rod Holder Bumper (650) to the Rod Holder (600).

FIG. 8 also shows an Upper Bumper Attachment Slot (655) for attaching an Upper

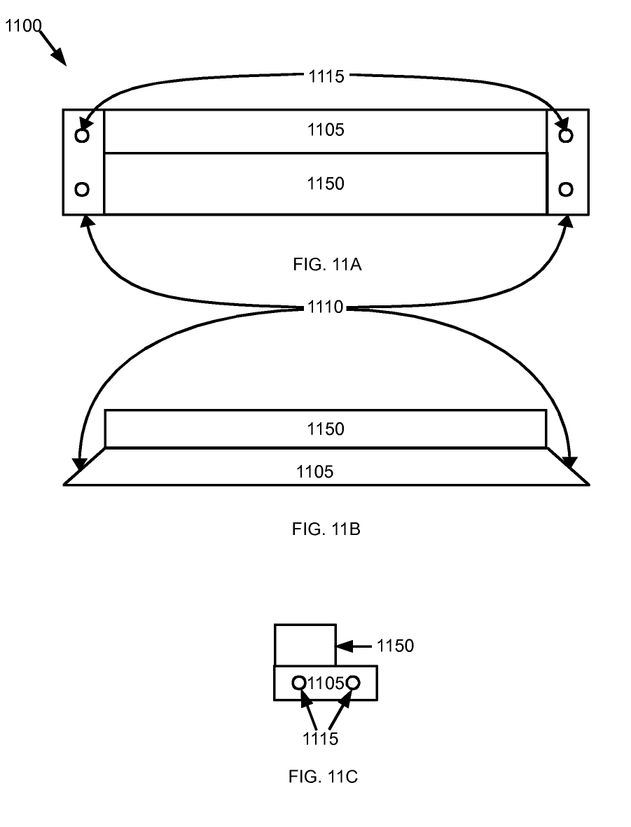

Bumper, (FIG. 11).

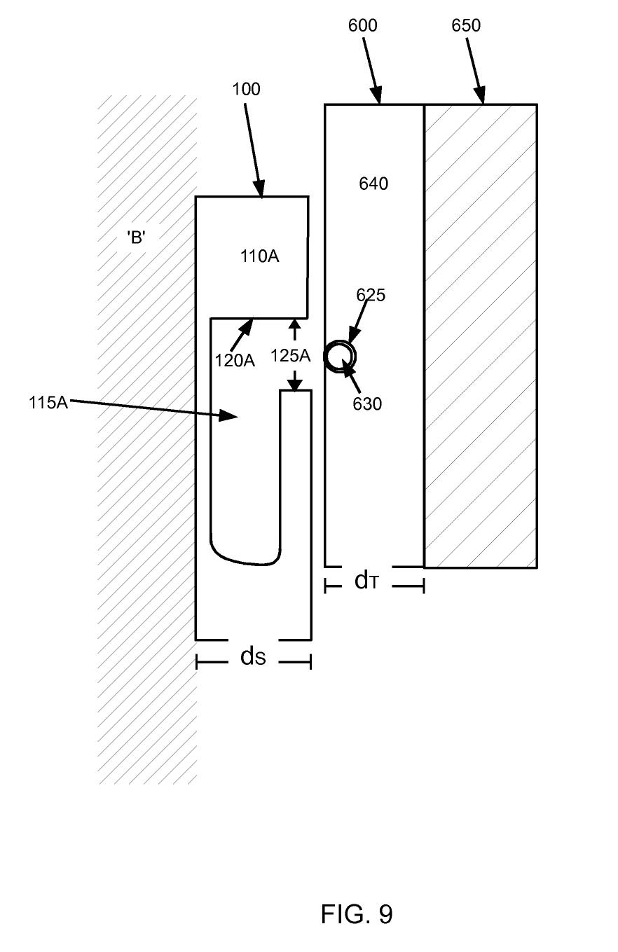

FIG. 9 shows a Rod Receiver (100) mounted to a Building (B′) with Rod Holder (600) in position for placement within Rod Receiver (100).

Shown in FIG. 9 is the Rod Receiver (100) with the Rod Receiver Side Plate (110A), within which is the Rod Receptacle (115A); within which are the Rod Receptacle Upper Guide Rail (120A), and the Rod Receptacle Slot (125A).

Also shown is the Rod Holder (600) with the Angled Side Plate (640), the Angled Side Plate Rod Holder (625) and the Inner Rod (630) protruding from the Angled Side Plate Rod Holder (625). Hidden behind the Angled Side Plate (640) is the at least one Outer Rod (635).

Also shown are two dimension lines, dₛ, representing the depth of the Rod Receiver (100), and d_{T}, representing the depth of the Rod Holder (600).

In a typical embodiment installed on a building around a dock bay, there would be at least one Rod Receiver (100) attached on a left side of the dock bay, at least one Rod Receiver (100) attached on a right side of the dock bay, with each Rod Receiver (100) mated to a Rod Holder (600).

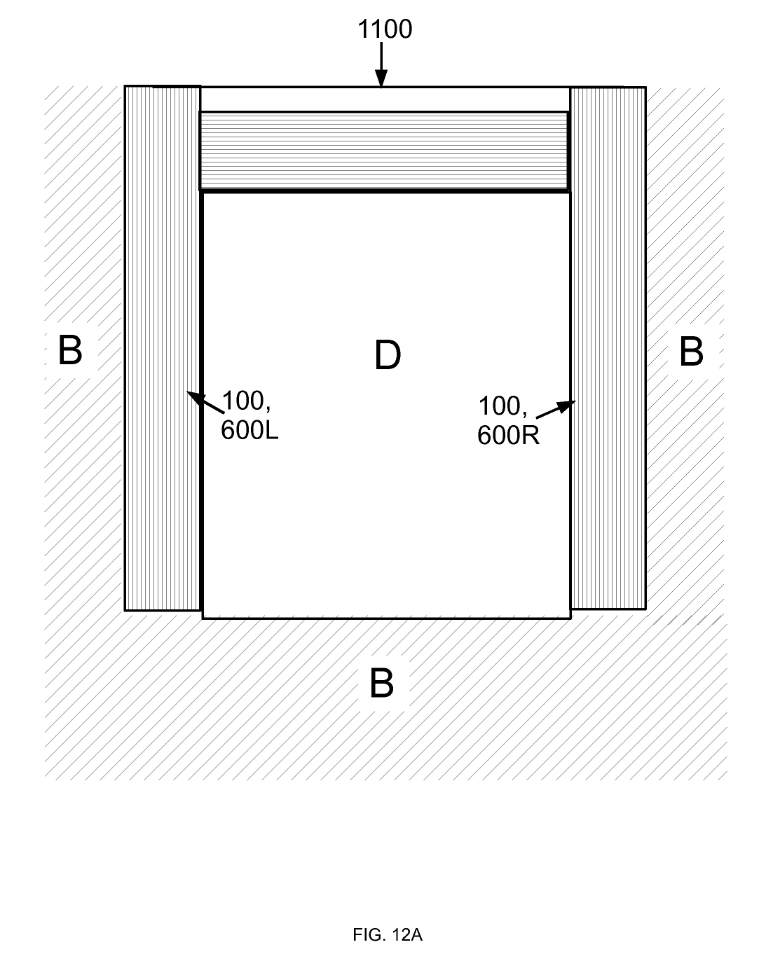

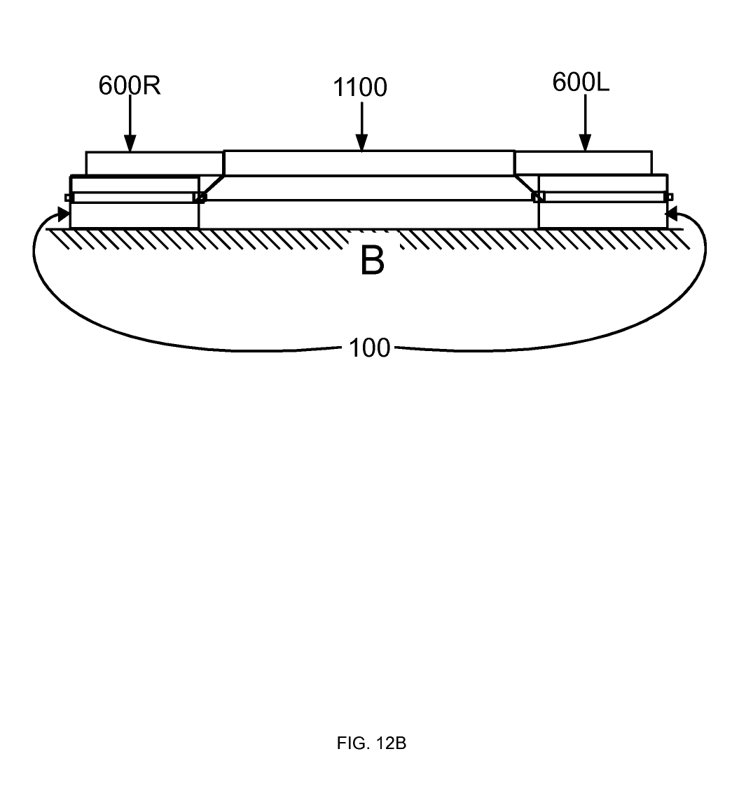

While the Rod Receivers (100) are left and right symmetric, as shown in FIG. 6A, 6B, 7 & 8, the Rod Holder (600) is not left and right symmetric. When installed, as shown in FIG. 12A and 12B, the Rod Holders (600) are mirror images of each other.

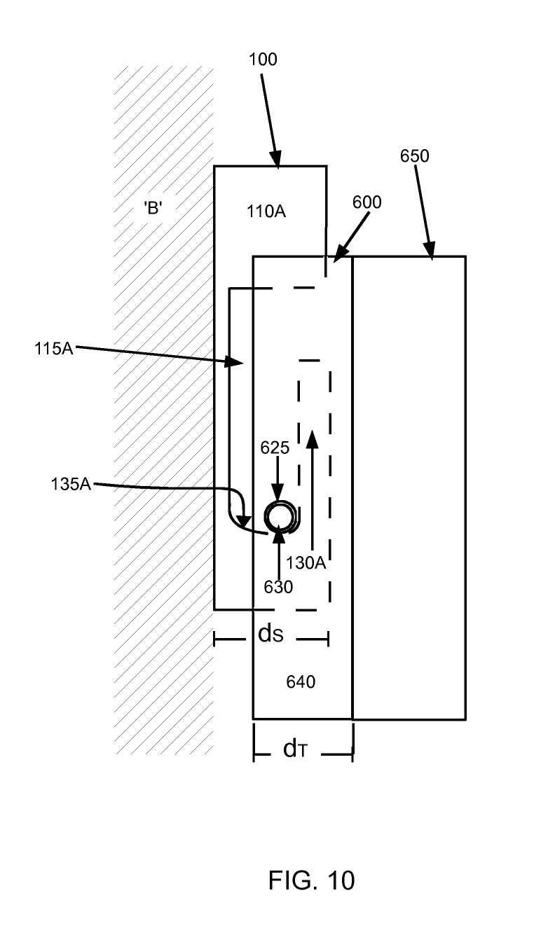

FIG. 10 shows Rod Holder (600) positioned within Rod Receiver (100).

Shown in FIG. 10 is the Rod Receiver (100) with the Rod Receiver Side Plate (110A), within which is the Rod Receptacle (115A); within which are Rod Receptacle Outer Guide Rail (130A) and the Rod Receptacle Lower Guide Rail (135A).

Also shown is the Rod Holder (600) with the Angled Side Plate (640), the Angled Side Plate Rod Holder (625) and the Inner Rod (630) protruding from the Angled Side Plate Rod Holder (625). Hidden behind the Angled Side Plate (640) is the at least one Outer Rod (635).

As represented by the dimension lines, the depth of the Rod Receiver (100) is more than the depth of the Rod Holder (600). This is necessary so that the Rod Holder (600) does not strike the Building.

FIG. 11A, 11B and 11C show an embodiment of an Upper Bumper (1100).

To provide additional cushioning, and acting as a weather barrier, a dock bay may have an Upper Bumper (1100) above the dock bay. The Angled Side Plate (640) of the Rod Holder (600) provides a securing point to affix the Upper Bumper (1100).

Shown in FIG. 11A, 11B and 11C are the Upper Bumper Base (1105), at least one Upper Bumper Angled Side Plate (1110), at least one Upper Bumper Attachment Port (1115) and the Upper Bumper Bumper (1150).

As with the other components of the PUSH PRESSURE RELEASE, the Upper Bumper Base (1105) and the at least one Upper Bumper Angled Side Plate (1110) would be a strong grade of steel or other metal so as to provide its function with high reliability. The Upper Bumper Base (1105) and the at least one Upper Bumper Angled Side Plate (1110) could be lesser grades of steel, iron, less strong metals, or even wood or plastic, with the functional exchange being the amount of force to which the PUSH PRESSURE RELEASE would be subjected against the reliability and life of the Upper Bumper (1100).

The at least one Upper Bumper Attachment Port (1115) within the at least one Upper Bumper Angled Side Plate (1110) provides a securing point to affix the Upper Bumper (1100) to the Angled Side Plate (640) at the Upper Bumper Attachment Slot (655) of the Rod Holder (600) as shown in FIG. 8.

In some embodiments, bolts are used with the at least one Upper Bumper Attachment Port (1115) to affix the Upper Bumper (1100) to the Angled Side Plate (640) of the Rod Holder (600).

Like the Rod Holder Bumper (650), the Upper Bumper Bumper (1150) is attached to the Upper Bumper Base (1105) so that the Upper Bumper Bumper (1150) is adjacent to any vehicle approaching the PUSH PRESSURE RELEASE.

In this configuration, the Upper Bumper Bumper (1150) cushions the building and the PUSH PRESSURE RELEASE from a full impact from a tractor-trailer or other docking vehicle.

The Upper Bumper Bumper (1150) may be made from any material, including rubber, wood, steel, iron, other natural materials, other natural elastic materials, recycled rubber, plastic, a composite of rubber and plastic, other artificial materials, or other artificial elastic materials.

The Upper Bumper Bumper (1150) may be any thickness, although the effectiveness of the Upper Bumper Bumper (1150) depends on both the material and thickness, as well as the vehicle contacting the PUSH PRESSURE RELEASE. In some embodiments, the Upper Bumper Bumper (1150) may be recycled rubber with a thickness of approximately six inches. The Upper Bumper Bumper (1150) may be attached to the Upper Bumper Base (1105) by any method suitable of attaching a bumper. In some embodiments, one or more fasteners may be used to attach the Upper Bumper Bumper (1150) to the Upper Bumper (1100). The one or more fasteners may be screws, bolts, clips, clamps, staples, rivets or other fasteners. In some embodiments, an adhesive may be used to attach the Upper Bumper Bumper (1150) to the Upper Bumper (1100).

FIG. 12A and 12B show an exemplary installation of the PUSH PRESSURE RELEASE.

Shown in FIG. 12A and 12B are a Building “B” with Dock “D”, a pair of Rod Receivers (100) attached to Building “B”, a pair of Rod Holders (600L and 600R) coupled to the Rod Receivers (100), and an Upper Bumper (1100) coupled to the pair of Rod Holders (600L and 600R) at the Angled Side Plates (640) of the Rod Holders.

FIG. 12B shows a view of an exemplary installation of the PUSH PRESSURE RELEASE as might be seen from looking over a building edge above the PUSH PRESSURE RELEASE. While the Rod Receivers (100) are left and right symmetric, the Rod Holder (600) is not left and right symmetric. When installed, as shown in FIG. 12A and 12B, the Rod Holders (600) are left and right mirror images of each other as indicated by Rod Holders 600L and 600R. This left-right mirror image permits installation of the Upper Bumper (1100) without additional attachments to the building.

These descriptions and drawings are embodiments and teachings of the disclosure. All variations are within the spirit and scope of the disclosure. This disclosure is not to be considered as limiting the claims to only the embodiments illustrated or discussed. Certain changes can be made in the subject matter without departing from the spirit and the scope of this invention. It is realized that changes are possible within the scope of this invention and it is further intended that each structure or element recited in any of the claims is to be understood as referring to all equivalent structure or elements. The following claims are intended to cover the invention as broadly as possible in whatever form it may be used.

What is claimed is:

1) A Rod Receiver comprising
a Rod Receiver Back Plate having a First Edge and a Second Edge, with
a First Rod Receiver Side Plate affixed to the Rod Receiver Back Plate at the First Edge, with a Second Rod Receiver Side Plate affixed to the Rod Receiver Back Plate at the Second Edge, with
a First Rod Receptacle within First Rod Receiver Side Plate, with
a Second Rod Receptacle within Second Rod Receiver Side Plate, with
a First Rod Receptacle Upper Guide Rail within the First Rod Receptacle adjacent to the First Rod Receiver Side Plate, with
a Second Rod Receptacle Upper Guide Rail within the Second Rod Receptacle adjacent to the Second Rod Receiver Side Plate, with
a First Rod Receptacle Slot having a height ‘d_{H}’, within the First Rod Receptacle adjoining and perpendicular to the First Rod Receptacle Upper Guide Rail, with
a Second Rod Receptacle Slot having a height ‘d_{H}’, within the Second Rod Receptacle adjoining and perpendicular to the Second Rod Receptacle Upper Guide Rail, with
a First Rod Receptacle Outer Guide Rail within the First Rod Receptacle adjoining and parallel to the First Rod Receptacle Slot, with
a Second Rod Receptacle Outer Guide Rail within the Second Rod Receptacle adjoining and parallel to the First Rod Receptacle Slot, with
a First Rod Receptacle Lower Guide Rail within the First Rod Receptacle adjoining the First Rod Receptacle Outer Guide Rail and terminating at the First Edge of the Rod Receiver Back Plate, with
a Second Rod Receptacle Lower Guide Rail within the Second Rod Receptacle adjoining the Second Rod Receptacle Outer Guide Rail and terminating at the Second Edge of the Rod Receiver Back Plate, with
a First Acute Incline Angle within the First Rod Receptacle formed between the First Rod Receptacle Outer Guide Rail and the First Rod Receptacle Lower Guide Rail, and
a Second Acute Incline Angle within the Second Rod Receptacle formed between the Second Rod Receptacle Outer Guide Rail and the Second Rod Receptacle Lower Guide Rail.

2) Rod Receiver of claim 1 wherein the First Rod Receptacle Upper Guide Rail comprises a substantially right angle to the Rod Receiver Back Plate.

3) Rod Receiver of claim 1 wherein the First Rod Receptacle Upper Guide Rail comprises an of approximately 90 degrees between the Rod Receiver Back Plate and the First Rod Receptacle Slot.

4) Rod Receiver of claim 1 further comprising an Rod Receiver Weather Seal affixed to Rod Receiver Back Plate above the First Rod Receptacle Upper Guide Rail.

5) Rod Receiver of claim 1 wherein the First Acute Incline Angle between the First Rod Receptacle Outer Guide Rail and the First Rod Receptacle Lower Guide Rail is approximately 10 to 40 degrees above horizontal.

6) Rod Receiver of claim 1 wherein the Rod Receiver comprises a material selected from the group consisting of steel, iron, wood and plastic.

7) Rod Receiver of claim 1 further comprising a First Rod Receiver Side Plate Connector affixed to the First Rod Receiver Side Plate and a Second Rod Receiver Side Plate Connector affixed to the Second Rod Receiver Side Plate.

8) A Rod Holder comprising
a Rod Holder Back Plate having a First Edge and a Second Edge, with
a Rod Holder Side Plate affixed to the Rod Holder Back Plate at the First Edge of the Rod Holder Back Plate,
a Rod Holder Side Plate Rod Port located within the Rod Holder Side Plate, with
an Angled Side Plate affixed to the Second Edge of the Rod Holder Back Plate, with an Angled Side Plate Rod Holder located within the Angled Side Plate and laterally across the Rod Holder Back Plate from the Rod Holder Side Plate Rod Port, with
at least one Outer Rod having a diameter ‘d_{R}’ and located within the Rod Holder Side Plate Rod Port and the Angled Side Plate Rod Holder and substantially perpendicular to the Rod Holder Side Plate, and
a Rod Holder Bumper.

9) Rod Holder of claim 8 further comprising an Inner Rod concentrically inside of the at least one Outer Rod.

10) Rod Holder of claim 8 wherein the at least one Outer Rod has a diameter of approximately one-half inch.

11) Rod Holder of claim 8 wherein the Rod Holder Bumper comprises a material selected from the group consisting of rubber, recycled rubber, wood, plastic, steel, iron, and a composite of rubber and plastic.

12) Rod Holder of claim 8 wherein the Rod Holder Bumper has a thickness of approximately six inches.

13) Rod Holder of claim 8 wherein the Rod Holder Bumper comprises a material selected from the group consisting of natural materials, elastic materials, and artificial material.

14) Rod Holder of claim 8 wherein the Rod Holder comprises a material selected from the group consisting of steel, iron, wood and plastic.

15) Rod Holder of claim 8 further comprising an Angled Side Plate Support Plate positioned at substantially a right angle to the Rod Holder Back Plate and between the Angled Side Plate Rod Holder and the Rod Holder Back Plate.

16) An apparatus for protecting a dock bay comprising a Rod Receiver coupled with a Rod Holder wherein a height ‘d_{H}’ of a Rod Receptacle Slot of the Rod Receiver is greater than a diameter ‘d_{R}’ of an at least one Outer Rod of the Rod Holder with a Rod Holder Bumper coupled to a Rod Holder Back Plate of the Rod Holder on a face opposite of an Angled Side Plate affixed to the Rod Holder Back Plate.

17) The apparatus for protecting a dock bay of claim 16 further comprising an Upper Bumper having an Upper Bumper Base, with at least one Upper Bumper Angled Side Plate affixed to the Upper Bumper Base, with at least one Upper Bumper Attachment Port within the at least one Upper Bumper Angled Side Plate and an Upper Bumper Bumper attached to the Upper Bumper Base adjacent to the at least one Upper Bumper Angled Side Plate.

18) apparatus for protecting a dock bay of claim 17 comprising a First Rod Receiver and a Second Rod Receiver, coupled respectively to a First Rod Holder and to a Second Rod Holder wherein the First Rod Holder is a mirror image of the Second Rod Holder, with at least one of the First Rod Holder and the Second Rod Holder coupled to the Upper Bumper at the at least one Upper Bumper Angled Side Plate.

19) Rod Receiver of claim 7 comprising a First Rod Receiver and a Second Rod Receiver with
the First Rod Receiver Side Plate Connector affixed to the First Rod Receiver below the First Rod Receptacle Lower Guide Rail and to the Second Rod Receiver at the Second Rod Receiver Side Plate above the Second Rod Receptacle Upper Guide Rail, with
the Second Rod Receiver Side Plate Connector affixed to the First Rod Receiver at the Second Rod Receiver Side Plate below the Second Rod Receptacle Lower Guide Rail, and to the Second Rod Receiver at the Second Rod Receiver Side Plate above the Second Rod Receptacle Upper Guide Rail.
